(19) United States
(12) Patent Application Publication
(10) Pub. No.: US 2014/0379753 A1
(43) Pub. Date: Dec. 25, 2014

(54) AMBIGUOUS QUERIES IN CONFIGURATION MANAGEMENT DATABASES

(71) Applicant: Hewlett-Packard Development Company, L.P., Houston, TX (US)

(72) Inventors: Yoni Roit, Yehud (IL); Eyal Regev, Yehud (IL); Einat Atedgi, Yehud (IL); Arik Sityon, Ganne Tiqwa (IL); Moshe Shamy, Yehud (IL)

(21) Appl. No.: 13/926,039

(22) Filed: Jun. 25, 2013

(51) Int. Cl. G06F 17/30

(52) U.S. Cl. CPC G06F 17/30424
USPC 707/771

(57) ABSTRACT

Disclosed herein are a system, computer-readable medium, and method for querying configuration management databases. A topological query from an interpretation of an ambiguous query is executed in a configuration management database.

A Configuration Management Database (“CMDB”) is a repository of information related to components of a system, such as an information technology system, a biological system, or a system of electronic components in a circuit. A CMDB contains configuration items and metadata that describes attributes and relationships therebetween. Configuration managers of a CMDB may describe technical, ownership, and relationship aspects of a configuration item.

### BRIEF DESCRIPTION OF THE DRAWINGS

FIG. 1 is a block diagram of an example system in accordance with aspects of the present disclosure.

FIG. 2 is a flow diagram of an example method in accordance with aspects of the present disclosure.

FIG. 3 is a working example in accordance with aspects of the present disclosure.

FIG. 4 is a further working example in accordance with aspects of the present disclosure.

### DETAILED DESCRIPTION

As noted above, a CMDB may contain associations between configuration items. Such relationships may be modeled as a data structure of interconnected nodes known as graphs. A connection or association between each pair of nodes may be known as an edge or arc. A graph data structure may also associate each edge with some edge value, such as a symbolic label or a numeric attribute (cost, capacity, length, etc.). Thus, arrangements of various sections of a system may be represented with a subgraph of nodes within the graph. These arrangements may be known as topologies. A CMDB may be queried with a topological query language (“TQL”). As with standard query language (“SQL”) in relational databases, TQL may retrieve data from a CMDB.

While SQL allows users to express queries in a high level language, TQL queries are typically expressed graphically. A TQL query may enable users to search a CMDB graph for all subgraph instances of a pattern graph specified by the user. Unfortunately, TQL is not as accessible as SQL, since TQL requires an intimate understanding of the theory and structure of a CMDB database. The complexity of TQL limits a CMDB's user base to professionals with advanced training. Such complexity makes the benefits of CMDB unavailable to most users. While some natural language interfaces to CMDB have been discussed, these interfaces may be incapable of adapting to different wordings of natural language expressions.

In view of the foregoing, disclosed herein are a system, non-transitory computer readable medium, and method for querying a CMDB database. In one example, a topological query derived from an interpretation of an ambiguous query is executed in a configuration management database. In another example, the ambiguous query may be a natural language query. In yet a further example, the interpretation may be based on a context-free grammar. The techniques disclosed herein may allow users to submit natural language queries to a CMDB without worrying about the phrasing of the query or about potential ambiguities therein. Rather than requiring expertise in graph database structures and design, the techniques disclosed herein may enable any user to obtain data from a CMDB. In turn, CMDB may be more widely accessible to users of all levels. The aspects, features and advantages of the present disclosure will be appreciated when considered with reference to the following description of examples and accompanying figures. The following description does not limit the application; rather, the scope of the disclosure is defined by the appended claims and equivalents.

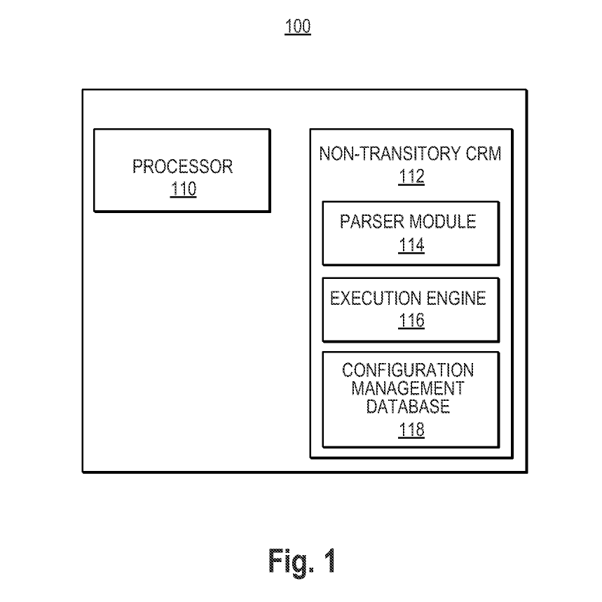

FIG. 1 presents a schematic diagram of an illustrative computer apparatus 100 for executing the techniques disclosed herein. The computer apparatus 100 may include all the components normally used in connection with a computer. For example, it may have a keyboard and mouse and/or various other types of input devices such as pen-inputs, joysticks, buttons, touch screens, etc., as well as a display, which could include, for instance, a CRT, LCD, plasma screen monitor, TV, projector, etc. Computer apparatus 100 may also comprise a network interface (not shown) to communicate with other devices over a network. The computer apparatus 100 may also contain a processor 110, which may be any number of well known processors, such as processors from Intel® Corporation. In another example, processor 110 may be an application specific integrated circuit (“ASIC”). Non-transitory computer readable medium (“CRM”) 112 may store instructions that may be retrieved and executed by processor 110. As will be discussed in more detail below, the instructions may include a parser module 114 and an execution engine 116. Furthermore, non-transitory CRM 112 may comprise a CMDB 118 that may be read and analyzed by processor 110 in accordance with aspects of the present disclosure. Non-transitory CRM 112 may be used by or in connection with any instruction execution system that can fetch or obtain the logic therefrom and execute the instructions contained therein.

Non-transitory computer readable media may comprise any one of many physical media such as, for example, electronic, magnetic, optical, electromagnetic, or semiconductor media. More specific examples of suitable non-transitory computer-readable media include, but are not limited to, a portable magnetic computer diskette such as floppy diskettes or hard drives, a read-only memory (“ROM”), an erasable programmable read-only memory, a portable compact disc or other storage devices that may be coupled to computer apparatus 100 directly or indirectly. Alternatively, non-transitory CRM 112 may be a random access memory (“RAM”) device or may be divided into multiple memory segments organized as dual in-line memory modules (“DIMMs”). The non-transitory CRM 112 may also include any combination of one or more of the foregoing and/or other devices as well. While only one processor and one non-transitory CRM are shown in FIG. 1, computer apparatus 100 may actually comprise additional processors and memories that may or may not be stored within the same physical housing or location.

The instructions residing in parser module 114 and execution engine 116 may comprise any set of instructions to be executed directly (such as machine code) or indirectly (such as scripts) by processor 110. In this regard, the terms “instructions,” “scripts,” and “applications” may be used interchangeably herein. The computer executable instructions may be stored in any computer language or format, such as in object code or modules of source code. Furthermore, it is understood that the instructions may be implemented in the form of hardware, software, or a combination of hardware and software and that the examples herein are merely illustrative.

As noted earlier, a CMDB, such as CMDB 118, may comprise a plurality of configuration item topologies and may be arranged as a graph data structure. Parser module 114 may instruct processor 110 to determine whether each interpretation of an ambiguous query expression can be converted into a topological query. In one example, the ambiguous query expression may be a natural language query expression. The conversion from a natural language query may be based on a predetermined context-free grammar. Execution engine 116 may instruct processor 110 to determine whether an interpretation of the ambiguous query is convertible to a topological query and to execute the topological query in the CMDB, if the interpretation of the ambiguous query is convertible to the topological query.

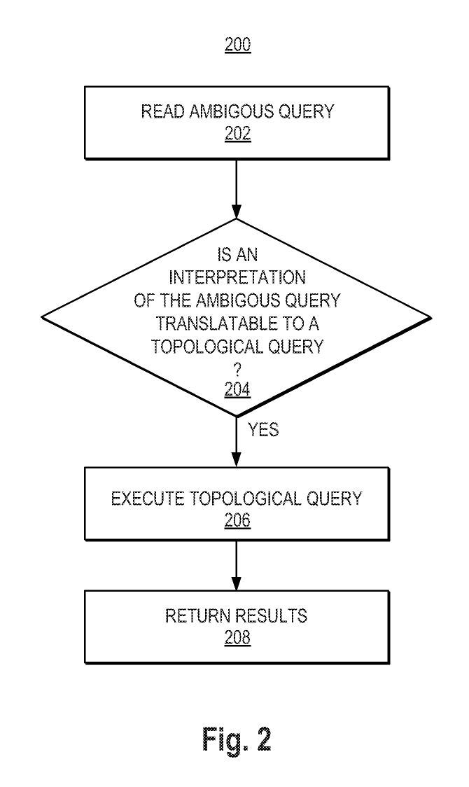

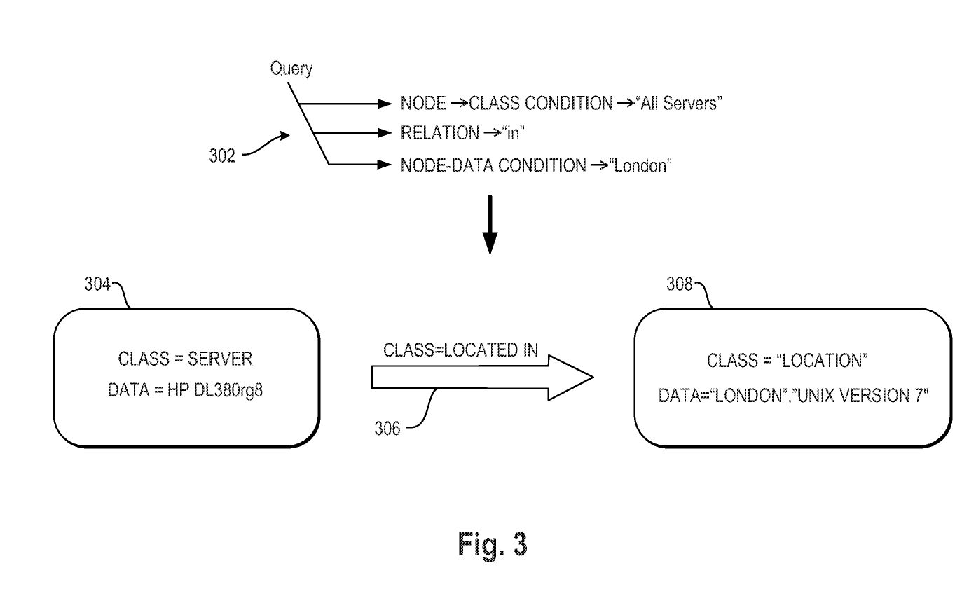

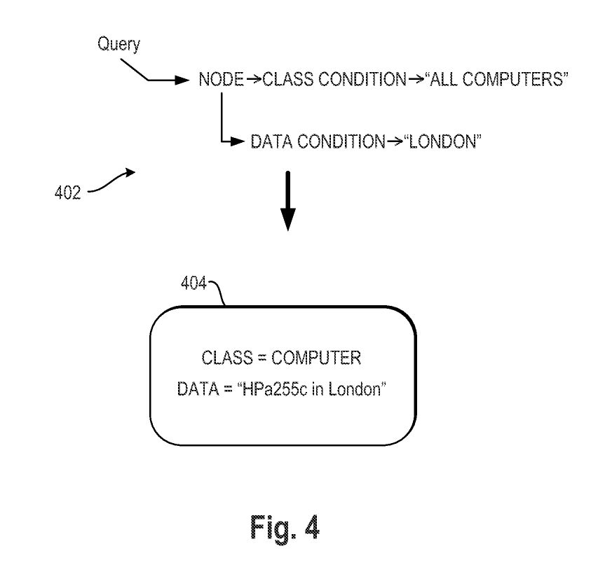

Working examples of the system, method, and non-transitory computer-readable medium are shown in FIGS. 2-4. In particular, FIG. 2 illustrates a flow diagram of an example method 200 for querying a CMDB. FIGS. 3-4 show working examples in accordance with aspects of the present disclosure. The actions shown in FIGS. 3-4 will be discussed below with regard to the flow diagram of FIG. 2.

As shown in block 202, an ambiguous query may be read. The query may be an ambiguous natural language query submitted by a user. As shown in block 204, it may be determined whether an interpretation of the ambiguous query is translatable to a topological query. As noted above, the interpretation may be based on a predetermined context free grammar. An example context free grammar will be explained in more detail below. In one aspect, a syntax tree data structure may be generated for each interpretation of the ambiguous query. In a further example, the syntax trees may be processed concurrently by multithreading parser module 114.

Referring now to FIG. 3, a syntax tree 302 is shown for an example natural language query containing the phrase “All servers in London.” The syntax tree 302 represents the first possible interpretation of the query, which is the original query itself. The example syntax tree 302 is an ordered, rooted tree that represents the syntax structure of a string according to the rewrite rules of a predetermined context free grammar. A context free grammar may be defined as a set of syntax variables, also known as non-terminal symbols, and a set of rules on how each syntax variable may be substituted to generate new symbol sequences. The grammar may be considered “context free” because the rewrite rules may be applied regardless of the context of the syntax variables.

The root of syntax tree 302 is an illustrative syntax variable “Query.” The syntax variable “Query” is shown associated with an example child syntax variable “Node.” In turn, “Node” is associated with yet another example syntax variable “Class Condition.” The illustrative syntax variables “Query,” “Node,” and “Class Condition” may belong to an example predetermined context free grammar. Furthermore, each association along the branch may represent a rewrite rule of the context free grammar. Thus, according to the rewrite rules, “Query” can be substituted with “Node;” and, “Node” may be substituted with “Class Condition.” The syntax variable “Class Condition” may then be associated with the phrase “All Servers,” which is a phrase from the natural language query. The words or phrases from the natural language query may be known as terminal symbols, since these symbols cannot be rewritten. Thus, according to the rewrite rule, “Class Condition” can be substituted with the phrase “All Servers.”

Syntax tree 302 also shows another illustrative syntax variable “Relation,” which is associated with the word “in” from the natural language query “All Severs in London.” Thus, the example context free grammar may specify that the syntax variable “Query” may be substituted with “Relation;” and, “Relation” can be substituted with the word “in.” The final branch from the root comprises associations between example syntax variables “Query,” “Node,” “Data Condition,” and terminates with an association to the word “London,” which is the last word from the example query.

Referring back to FIG. 2, each interpretation translatable to a topological query may be executed, as shown in block 206. As shown in block 208, the results from the CMDB may be returned. Referring back to FIG. 3, to determine whether syntax tree 302 may be executed as a TQL query, words in the interpretation may be compared to those of metadata associated with configuration items in the database. In one example, when a word in an interpretation of the ambiguous natural language query at least partially matches that of metadata associated with at least one configuration item, the interpretation may be executed as a topological query in the CMDB. The metadata may comprise attributes associated with each configuration item in the database.

FIG. 3 depicts example results returned from the CMDB. These results may be returned in response to a topological query derived from syntax tree 302. The example results contain two nodes 304 and 308 and an edge 306 that associates the nodes. The metadata associated with node 304 includes the class name “SERVER,” which partially matches the natural language query “All servers in London.” Other metadata associated with node 304 includes “HPDL380rg8,” which is a server model. The edge 306 is shown associated with the class “Located in,” which partially matches the term “in” of the query. Node 308 is of class “Location” and other metadata associated therewith contains the term “London.” Thus, one reply to the query “All servers in London” may be “HPDL380rg8,” which is the name of a server in London.

Referring now to FIG. 4, a second example syntax tree 402 is shown. As noted above, a thread may be generated for each interpretation in order to accelerate the parsing and interpretation of the incoming query. Syntax tree 402 may represent another possible interpretation of the received natural language query. Here, syntax tree 402 may also start with a root syntax variable of “Query” that is associated with the syntax variable “Node,” which in turn is associated with “Class Condition.” However, in syntax tree 402, the rewrite rule of the example context free grammar specifies that “Class Condition” may also be replaced with the terminal symbol “computer,” when the word “server” is detected. The term “computer” may be considered a synonym for “server.” Such synonyms for words in the metadata may also be included in the context free grammar for disambiguation. Syntax tree 402 also shows associations between the syntax variables “Query,” “Data condition” and the term “London” from the natural language query. This syntax tree may be executed as yet another TQL query that returns the node 404 shown in FIG. 4. Node 404 is shown having a class of “computer,” which matches the synonym “computer” in the syntax tree 402. Furthermore, other metadata associated with Node 404 also contains the term “HPa255c in London,” which partially matches the data condition “London” from syntax tree 402. Thus, another result that may be returned in response to the query “All servers in London” is “HPa255c.” The results from FIG. 3 and FIG. 4 may be forwarded to a ranker module that may rank the results in accordance with their likeness to the terms in the query.

Advantageously, the foregoing system, method, and non-transitory computer readable medium facilitates interactions between a CMDB and users that may not be familiar with the intricacies of CMDB databases or graph theory. In this regard, ambiguous terms in the query may be accommodated with a predefined context free grammar. In turn, the benefits of CMDB may be made accessible to a larger user base and may be used for many different types of systems.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein; rather, processes may be performed in a different order or concurrently and steps may be added or omitted.

1. A system comprising:
a configuration management database comprising a plurality of configuration item topologies, the database to be arranged as a graph data structure;
a parser module which, if executed, instructs at least one processor to detect each interpretation of an ambiguous query expression based on a predetermined context-free grammar; and
an execution engine which, if executed, instructs at least one processor to determine whether an interpretation of the ambiguous query is convertible to a topological query and to execute the topological query in the configuration management database, if the interpretation of the ambiguous query is convertible to the topological query.

2. The system of claim 1, wherein the parser module, if executed, further instructs at least one processor to generate a syntax tree data structure for each detected interpretation of the ambiguous query expression.

3. The system of claim 1, wherein the execution engine, if executed, instructs at least one processor to compare words in the interpretation of the ambiguous query to those of metadata associated with configuration items in the database to determine whether the interpretation is convertible to the topological query.

4. The system of claim 3, wherein the execution engine, if executed, executes the topological query when a word in the interpretation of the ambiguous query at least partially matches that of metadata associated with at least one configuration item.

5. The system of claim 3, wherein the metadata comprises attributes associated with each configuration item in the database.

6. The system of claim 3, wherein the context free grammar comprises synonyms for words in the metadata associated with each configuration item in the database.

7. A non-transitory computer readable medium having instructions therein which, if executed, cause at least one processor to:
determine whether a received natural language query is ambiguous;
determine each possible interpretation of the natural language query, if the natural language query is ambiguous;
determine whether each possible interpretation can be converted into a topological query executable in a configuration management database;
if a possible interpretation can be converted into the topological query, execute the topological query in the configuration management database; and
respond to the natural language query with data from the configuration management database obtained with the topological query.

8. The non-transitory computer readable medium of claim 7, wherein the instructions therein, if executed, further instruct at least one processor to generate a syntax tree data structure for each interpretation of the natural language query, if the natural language query is ambiguous.

9. The non-transitory computer readable medium of claim 7, wherein the instructions therein, if executed, instruct at least one processor to compare words in each interpretation to those of metadata associated with configuration items in the database to determine whether each possible interpretation can be converted into the topological query.

10. The non-transitory computer readable medium of claim 9, wherein the instructions therein, if executed, further instruct at least one processor to execute the topological query when a word in an interpretation of the natural language query at least partially matches that of metadata associated with at least one configuration item.

11. The non-transitory computer readable medium of claim 9, wherein the metadata comprises attributes associated with each configuration item in the database.

12. The non-transitory computer readable medium of claim 9, wherein each possible interpretation is to be based on a context free grammar comprising synonyms for words in metadata associated with each configuration item in the database.

13. A method comprising
determining, using at least one processor, whether an interpretation of an ambiguous natural language query is translatable to a topological query executable in a configuration management database;
executing, using at least one processor, the topological query, if the interpretation of the ambiguous natural language query is translatable to the executable topological query; and
responding, using at least one processor, to the natural language query with data obtained from the configuration management database via the topological query.

14. The method of claim 13, further comprising generating, using at least one processor, a syntax tree data structure for each interpretation of the ambiguous natural language query.

15. The method of claim 13, further comprising comparing, using at least one processor, words in each interpretation to those of metadata associated with configuration items located in the database.

16. The method of claim 15, further comprising executing, using at least one processor, the topological query, when a word in the interpretation of the natural language query at least partially matches that of metadata associated with at least one configuration item.

17. The method of claim 15, wherein the metadata comprises attributes associated with each configuration item in the database.

18. The method of claim 15, wherein the interpretation is based on a context free grammar comprising synonyms for words in the metadata associated with each configuration item in the database.
